(19) United States
(12) Patent Application Publication
(10) Pub. No.: US 2023/0146602 A1
(43) Pub. Date: May 11, 2023

(54) METHOD FOR LAYER-BY-LAYER DEPOSITION OF CONCRETE

(71) Applicant: Universiteit Gent, Gent (BE)

(72) Inventors: Yaxin Tao, Woluwe-Saint-Lambert (BE); Geert de Schutter, Erpe-Mere (BE); Kim van Tittelboom, Aaigem (BE); Karel Lesage, Nazareth (BE)

(73) Assignee: Universiteit Gent, Gent (BE)

(21) Appl. No.: 17/920,413

(22) PCT Filed: Apr. 22, 2021
(86) PCT No.: PCT/EP2021/060557

§ 371 Date: Oct. 21, 2022

(30) Foreign Application Priority Data
Apr. 24, 2020 (EP) 20171258.5

(51) Int. Cl. B28B 1/00; B28C 5/06; B28C 7/04; B28C 9/00; B33Y 40/10

(52) U.S. Cl. CPC B28B 1/001; B28C 5/06; B28C 7/0413; B28C 9/002; B33Y 40/10; B33Y 10/00

(57) ABSTRACT

The invention relates to a method for layer-by-layer deposition of concrete by providing extrudable concrete. A first flow comprising a binder material and water and a second flow comprising a carrier material, an additional component and water are mixed in a static mixer to form a third flow of extrudable concrete. The material of the second flow has a shorter initial setting time than the material of the first flow. The first flow has a first viscosity V1 and the second flow has a second viscosity V2 so that the ratio V1/V2 ranges between 1/40 and 40. The third flow has a viscosity larger than the viscosity of the first flow and the second flow and a yield stress larger than the yield stress of the first flow and the second flow. The material of the third flow has an initial setting time shorter than initial setting time of the first flow.

The invention further relates to a system to extrude concrete, in particular for layer-by-layer deposition of concrete.

### FIELD OF THE INVENTION

The present invention relates to a method for layer-by-layer depsosition of concrete by providing extrudable concrete having a high fluidity (high pumpability) before extrusion and a low fluidity (high buildability) after extrusion. The present invention further relates to a system for layer-by-layer deposition of concrete.

### BACKGROUND ART

Concrete is a widely used building material. With the widespread use of mineral additions and chemical admixtures, a large number of optimized mixtures and processes have been proposed to meet different requirements. In recent decades, pumping has been developed as an indispensable technique in concrete construction. Unfortunately, conflicts in requirements of fresh concrete performance still exist during the pumping process and the post-pumping process.

To obtain a good pumpability of concrete good fluidity retention is required. A good fluidity retention is beneficial for decreasing pumping pressure and resuming pumping operation if a (short) interruption is experienced, for example a short interruption due to a delay of material feeding. On the other hand, excellent buildability should be reached in formwork casting and in building methods without formwork. Buildability is defined as the material's ability to maintain its shape once extruded, for example printed, without flowing. In formwork casting a good buildability is required to avoid leakage of formworks or excessive formwork pressure during casting. This requirement is even more challenging in building methods without formwork such as 3D concrete printing to avoid deformation or collapse of material being extruded.

It is clear that these requirements (high fluidity and good buildability) are contradictory. This contradiction remains one of the biggest challenges to extrude concrete and in particular in 3D printing of concrete.

Several kinds of admixtures have been proposed to influence either the fluidity or buildability of concrete. Dispersing agents and (super)plasticizers are for example added to reduce yield stress and viscosity and thus to obtain a high fluidity. Retarders are added to obtain a larger initial setting time (open time). On the other hand, addition of viscosity modifying admixtures and accelerators has been used in pre-mixed materials for increasing viscosity and yield stress respectively. Furthermore, the addition of nanoclay has been proposed to enhance thixotropy of concrete.

Furthermore, the addition of a liquid accelerator into the extrudable (printable) material at the nozzle has been proposed. It is however complicated to inject a liquid accelerator into fresh concrete. Such mixing steps require dynamic mixers. Dynamic mixing processes are complicated and up to now such methods do not result in homogeneous mixing.

### SUMMARY OF THE INVENTION

It is an object of the present invention to provide a method to provide extrudable concrete avoiding the problems of the prior art.

It is also an object of the present invention to provide a method for layer-by-layer deposition of concrete.

It is another object of the present invention to provide a method to provide extrudable concrete that has a homogeneous composition.

It is a further object of the present invention to provide a robust method to provide extrudable concrete not requiring complicated mixing processes, not requiring movable parts, nor requiring pressurized air.

It is also an object of the present invention to provide extrudable concrete having a sufficiently high fluidity to allow pumping and a high buildability to allow the formation of structures, in particular 3D structures.

It is a further object of the present invention to provide a method to extrude concrete by mixing two flows in a static mixer whereby the extruded concrete has an increased viscosity and/or an increased yield stress and/or a decreased initial setting time compared to the material of the two flows.

It is another object of the present invention to provide a method to provide extrudable concrete allowing to use an accelerator for setting and/or hardening concrete or an alkali activator, either in liquid or in solid form.

It is a further object to provide a system for layer-by-layer deposition of concrete.

According to a first aspect of the present invention a method for layer-by-layer deposition of concrete by providing extrudable concrete and preferably continuously providing extrudable concrete. The method comprises the steps of
supplying a first flow and a second flow to a static mixer, preferably pumping a first flow and a second flow to a static mixer. The first flow comprises a first material and water. The first material comprises a binder material and has a first initial setting time T1. The first flow has a first viscosity V1 ranging between 0.1 Pa·s and 60 Pa·s and a first yield stress Y1. The second flow comprises a second material and water. The second material comprises a carrier material comprising powdery material and at least one additional compound. The powdery material has preferably a particle size lower than 100 μm, for example a particle size ranging from 0.1 μm to 100 μm, from 1 μm to 100 μm or from 10 μm to 100 μm. Preferably, the powdery material has an average powder size lower than 100 μm, for example an average particle size ranging from 0.1 μm to 100 μm, from 1 μm to 100 μm or from 10 μm to 100 μm. The additional compound is a compound that, when added to the first material to form a mixture of the first material and the additional compound, is able to reduce the initial setting time of the mixture of the first material and the additional compound compared to the first initial setting time T1.
The second material has a second initial setting time T2. The second flow has a second viscosity V2 ranging between 0.1 Pa·s and 60 Pa·s and a second yield stress Y2. The first viscosity V1 and the second viscosity V2 define a ratio V1/V2 ranging between 1/40 and 40. The second initial setting time T2 is equal to or larger than the first initial setting time T1. Preferably the second initial setting time T2 is larger than the first initial setting time T1.
mixing the first flow and the second flow in the static mixer to obtain a third flow comprising the extrudable concrete. The third flow comprises a mixture of the first material and the second material and water. The mixture of the first material and the second material has a third initial setting time T3. The third flow has a third viscosity V3 and a third yield stress Y3. The third viscosity V3 is larger than the first viscosity V1 and larger than the second viscosity V2. The third yield stress Y3 is larger than the first yield stress Y1 and larger than the second yield stress Y2. The third initial setting time T3 is shorter than the first initial setting time T1.
dispensing the third flow comprising extrudable concrete from the static mixer.

The term ‘initial setting time’ also referred to as ‘initial set time’ or ‘initial open time’ refers to the time elapsed between the moment water (or alkali activated solution) is added to the material or the mixture of materials to the time at which paste starts losing its plasticity. For the purpose of this invention, the initial setting time is determined by a penetration resistance method. The initial setting time is the time period elapsed between the addition of water (or alkali activated solution) to the material or mixture of materials until the material formed reaches a penetration resistance of 3.5 N/mm².

The first initial setting time T1 and the second initial setting time T2 is the time period elapsed between the addition of water (or alkali activated solution) to the first material of the first flow, respectively to the second material of the second flow to the moment the material formed reaches a penetration resistance of 3.5 N/mm². To mix the material a standard rotational mixer is used.

The third initial setting time T3 is the time period elapsed between the addition of water to a mixture of the first material of the first flow and the second material of the second flow to the paste formed reaches a penetration of 3.5 N/mm². To mix the first material and the second material preferably a standard rotational mixer is used.

The term ‘yield stress’ refers specifically to static yield stress, the stress required for initiating a flow. The static yield stress is measured by a stress growth test. For the measurement of the yield stress a vane spindle with several thin blades is used. To measure the yield stress a constant low speed is preset on the rotary rheometer. The maximum yield stress, which can be detected during the measurement, is the static yield stress.

Preferably, the second initial setting time T2 is substantially larger than the first initial setting time T1. The second initial setting time T2 is for example at least 2 times the first initial setting time T1. In preferred embodiments the second initial setting time T2 is at least 10 times the first initial setting time T1. In particular embodiments the second initial setting time T2 is at least 20 times the first initial setting time T2 or at least 40 times the initial setting time T1.

Preferably, the third initial setting time T3 is substantially shorter than the first initial setting time T1. The third initial setting time T3 is for example shorter than half of the first initial setting time T1. More preferably, the third initial setting time T3 is shorter than one fifth of the first initial setting time T1. More preferably, the third initial setting time T3 is shorter than one tenth of the first initial setting time T1, shorter than one twentieth of the first initial setting time or shorter than one fortieth of the first initial setting time T1.

As the second initial setting time T2 is equal or larger than the first initial setting time T1, the third initial setting time T3 is also shorter than the second initial setting time T2.

The first flow and the second flow are preferably flowable (=capable of flowing). More preferably, the first flow and the second flow are flowable and pumpable (=capable of being pumped). This means that the fluidity and viscosity of the first flow and of the second flow should meet particular requirements.

The fluidity of the first and second flow is preferably sufficiently high. The term ‘fluidity’ refers the ability of materials to flow. The fluidity can be measured by a flow table test. Freshly mixed material is placed inside a cone-shaped mold in two layers. Then the mold is removed and the vibrating table is dropped 25 times in 15 seconds. The final diameter represents the fluidity of the fresh material.

The first viscosity V1 of the first flow is preferably ranging between 0.1 Pa·s and 60 Pa·s. More preferably, the first viscosity V1 is at least 1 Pa·s, at least 2 Pa·s, at least 3 Pa·s, at least 4 Pa·s, at least 5 Pa·s or at least 10 Pa·s. The first viscosity is for example ranging between 1 Pa·s and 50 Pa·s or between 1 Pa·s and 40 Pa·s.

The second viscosity V2 of the second flow is preferably ranging between 0.1 Pa·s and 60 Pa·s. More preferably, the second viscosity V2 is at least 2 Pa·s, at least 3 Pa·s, at least 4 Pa·s, at least 5 Pa·s or at least 10 Pa·s. The first viscosity is for example ranging between 1 Pa·s and 50 Pa·s or between 1 Pa·s and 40 Pa·s.

The term ‘viscosity’ refers to the resistance of a fluid to deform at a given shear rate. The viscosity of the first flow, the second flow and the third flow is measured by a flow curve test, normally performed on a rotary rheometer. Most rotary rheometers work according to the Searle principle: a motor drives a geometry inside a fixed cup. The rotational speed of the bob is preset and produces the motor torque that is needed to rotate the measuring geometry. This torque has to overcome the viscous forces of the tested materials and is therefore a measure for its viscosity.

The ratio of the first viscosity V1 to the second viscosity V2, V1/V2 ranges preferably between 1/40 and 40. More preferably, the ratio V1/V2 ranges between 1/20 and 20. Even more preferably, the ratio V1/V2 ranges between 1/10 and 10, between 1/5 and 5 or between 1/2 and 2. In particular preferred embodiments the ratio V1/V2 ranges 0.7 and 1.3, for example between 0.8 and 1.2 or between 0.9 and 1.1.

For the method according to the present invention, the first viscosity V1, the second viscosity V2 and the ratio of the first viscosity V1 to the second viscosity V2, V1/V2 are crucial to meet the requirements to obtain a homogeneously mixed concrete using a static mixer suitable for layer by-layer deposition.

Preferably, the third viscosity V3 is at least 2 times the first viscosity V1 or at least 2 times the second viscosity V2. Preferably, the third viscosity V3 is at least 2 times the first viscosity V1 and at least 2 times the second viscosity V2. More preferably, the third viscosity V3 is at least 5 times the first viscosity V1, at least 10 times the first viscosity V1, at least 20 times the first viscosity V1, at least 40 times the first viscosity V1, at least 100 times the first viscosity V1 or the third viscosity V3 is at least 5 times the second viscosity V2, at least 10 times the second viscosity V2, at least 20 times the second viscosity V2, at least 40 times the second viscosity V2, at least 100 times the second viscosity V2.

The first yield stress Y1 of the first flow is preferably at most 500 Pa. More preferably, the first yield stress Y1 is at most 100 Pa, at most 50 Pa, or at most 10 Pa.

The second yield stress Y2 of the second flow is preferably at most 500 Pa. More preferably, the second yield stress Y2 is at most 100 Pa, at most 50 Pa, or at most 10 Pa.

The first yield stress Y1 and the second yield stress Y2 define a ratio Y1/Y2. Preferably, the ratio of the first yield stress Y1 and the second yield stress Y2, Y1/Y2 ranges between 1/40 and 40. More preferably, the ratio Y1/Y2 ranges between 1/20 and 20. Even more preferably, the ratio Y1/Y2 ranges between 1/10 and 10, between 1/5 and 5 or between 1/2 and 2. In particular preferred embodiments the ratio Y1/Y2 ranges 0.7 and 1.3, for example between 0.8 and 1.2 or between 0.9 and 1.1.

Preferably the third yield stress Y3 is at least 200 times the yield stress Y1 or at least 200 times the yield stress Y2. More preferably, the third yield stress Y3 is at least 500 times the first yield stress Y1 or at least 500 times the second yield stress Y2.

Preferably, the third yield stress Y3 is at least 200 Pa, at least 500 Pa, at least 1000 Pa or at least 10000 Pa.

In preferred embodiments, the third viscosity V3 is at least 2 times the first viscosity V1 or at least 2 times the second viscosity V2 and the third yield stress Y3 is at least 200 times the first yield stress Y1 or at least 200 times the second yield stress Y2. In particular preferred embodiments the third viscosity V3 is at least 40 times the first viscosity V1 or at least 40 times the second viscosity V2 and the third yield stress Y3 is at least 500 times the first yield stress Y1 or at least 500 times the second yield stress Y2.

The first flow is supplied to the static mixer with a flow rate F1 and the second flow is supplied to the static mixer with a flow rate F2. The first flow rate F1 ranges preferably between 0.5 L/min and 100 L/min, as for example 1 L/min, 10 L/min, 20 L/min or 50 L/min. The second flow rate ranges preferably between 0.5 L/min and 100 L/min, as for example 1 L/min, 10 L/min, 20 L/min or 50 L/min.

Preferably, the ratio of the flow rate F1 over the flow rate F2, F1/F2 ranges between 1/10 and 10 and more preferably between 1/5 and 5, for example between 1/2 and 2.

The first flow is preferably supplied to the static mixer by pumping. The first flow is for example introduced to the static mixer by pumping the first material and water by means of a first pump to an inlet of the static mixer. The second flow is for example introduced to the static mixer by pumping the second material and water by means of a second pump to an inlet of the static mixer.

Preferably, the first pump and the second pump are simultaneously activated. This means that the first pump and the second pump are preferably working during the same time interval and thus that the first and second pump are preferably activated at the same moment in time and deactivated at the same moment in time.

The first flow is preferably introduced to a first inlet of the static mixer and the second flow is preferably introduced to a second inlet of the static mixer. It is clear that the material of the first flow and the material of the second flow is preferably pumpable.

As mentioned above the first flow comprises a first material and water. The first flow can be introduced from a storage container comprising the first material and water. Alternatively, a flow of the first material is conveyed from a storage container comprising the first material towards the static mixer and water is added to the flow of the first material for example (shortly) before the flow of the first material enters the inlet of the static mixer.

The first material comprises a binder material and may further comprise further compounds such as one or more plasticizers, one or more superplasticizers, one or more retarders and/or one or more accelerators.

The first material may further comprise sand. Preferably, the amount of sand is lower than 60% volume of the first material or lower than 50% volume of the first material.

The first material has preferably an initial setting time T1 larger than 60 minutes and more preferably an initial setting time T1 larger than 120 minutes, larger than 240 minutes or larger than 480 minutes.

The binder material may comprise a cementitious binder material, an alkali activated binder material or a combination of a cementitious binder material and an alkali activated binder material.

A cementitious binder material may comprise any building material which may be mixed with a liquid, for example water, to form a plastic paste. Cementitious binder material comprises for example cement such as Portland cement, lime and calcium sulfoaluminate cement. Cementitious material may further comprise aggregates such as gravel, crushed stone and/or sand. Cementitious material may also comprise reactive and/or non-reactive additions. Furthermore cementitious material may comprise supplementary cementitious materials (SCMs) such as fly ash, slags (blast furnace slags) and/or silica fumes.

An alkali activated binder material, sometimes referred to as geopolymer binder material, comprises material having a high silica and/or alumina content that under alkaline conditions (induced by an alkali activator) forms a plastic paste. Alkali activated binder material may comprise either artificial or natural silicious and/or aluminous material. Artificial materials include for example industrial by-products such as granulated blast furnace slag, granulated phosphorus slag, ferrous and non-ferrous slag, coal fly ash, silica fumes and calcined products such as metakaolin. Natural materials comprise for example volcanic glasses such as volcanic ash, zeolites, siliceous pozzolans, diatomaceous earth.

The second flow comprises a second material and water. The second flow can be introduced from a storage container comprising the second material and water. Alternatively, a flow of the second material is conveyed from a storage container comprising the second material towards the static mixer and water is added to the flow of the second material for example (shortly) before the flow of the second material enters the inlet of the static mixer.

The second material comprises a carrier material and at least one additional compound. The carrier material comprises a powdery material. The powdery material has preferably a particle size lower than 100 μm, lower than 80 μm or lower than 50 μm. More preferably, the average particle size of the powdery material is ranging between 0.1 μm and 100 μm, between 1 μm and 100 μm or between 10 μm and 100 μm. The average particle size is for example ranging between 0.1 μm and 80 μm, between 0.1 μm and 50 μm, between 0.1 μm and 30 μm, between 0.1 μm and 10 μm or between 1 μm and 10 μm. The average particle size of the powdery material is for example 3 μm, 4 μm or 5 μm.

The particle size (average particle size) can be determined by any method known in the art. A preferred method to determine the particle size (average particle size) comprises laser diffraction analysis.

In order to obtain a flow that is flowable and preferably also pumpable, the volume fraction of the powdery carrier material should be sufficiently high. The carrier material has preferably a volume fraction of at least 20% of the second material. More preferably, the carrier material has a volume fraction of at least 30% or of at least 40% volume of the second material.

The second flow may further comprise one or more plasticizers, one or more superplasticizers, one or more retarders and/or one or more accelerators.

The second flow may further comprise sand. Preferably, the amount of sand is lower than 70% volume of the second material or lower than 60% volume of the second material. The second flow is preferably free of the binder material of the first flow.

The second material has preferably an initial setting time T2 equal to or larger than the initial setting time T1 of the first material. Preferably, the initial setting time T2 is at least 120 minutes and more preferably at least 240 minutes, at least 480 minutes or at least 960 minutes.

The carrier material preferably comprises limestone filler, such as limestone powder, mineral powder as for example sand or quartz powder or combinations thereof.

The additional compound may comprise a hardening and/or setting accelerator or an alkali activator. In case the binder material of the first flow comprises a cementitious binder material, the additional compound comprises preferably a hardening and/or setting accelerator. In case the binder material of the first flow comprises an alkali activated binder material, the additional compound preferably comprises an alkali activator.

A setting accelerator refers to a compound that is decreasing the time to begin the transition of a mix from the plastic to the rigid state.

A hardening accelerator refers to a compound that is increasing the rate of development of early strength in the concrete with or without affecting the setting time, in particular the initial setting time.

Examples of hardening and/or setting accelerators comprise (soluble) inorganic salts, preferably (soluble) inorganic salts of alkali and earth alkali metals, (soluble) organic salts and compounds selected from the group consisting of amines and/or organic acids (for example carboxylic and hydrocarboxylic acids) and their salts.

Preferred examples of inorganic salts comprise hydroxides, chlorides, bromides, fluorides, carbonates, nitrates, nitrites, thiocyanates, sulfates, thiosulfates, perchlorates, silicates and aluminates. Particular examples comprise sodium silicate, sodium aluminate, aluminium chloride, sodium fluoride, calcium chloride, calcium aluminate, silicate, magnesium carbonate, and calcium carbonate.

Preferred examples of organic salts and compounds comprise salts of triethanolamine, triisopropanolamine, calcium formate, calcium acetate, calcium propionate and calcium butyrate.

Examples of alkali activators comprise metal hydroxides, non-silicate weak acid salts, silicates, aluminates, aluminosilicates and non-silicate strong acids salts.

Preferred metal hydroxides comprise alkali metal hydroxides such as sodium hydroxide or potassium hydroxide.
Examples of non-silicate weak acids salts comprise weak acid salts selected from the group consisting of carbonates, sulfites, phosphates and fluorides.
Examples of non-silicate strong acid salts comprise sulfates.

The third flow comprises a mixture of the first material and the second material and water.

Optionally, the third flow further comprises one or more additives.

The mixture of the first material and the second material has a third initial setting time T3. The third initial setting time T3 is shorter than the first initial setting time T1. Preferably, the third initial setting time T3 is shorter than 60 minutes, shorter than 30 minutes or shorter than 15 minutes.

According to a second aspect of the present invention, a system for layer-by-layer deposition of concrete is provided. The system comprises a static mixer having at least a first inlet for introducing a first flow in the static mixer, at least a second inlet for introducing a second flow in the static mixer and at least an outlet for providing a third flow comprising the extrudable concrete. The first flow comprises a first material and water. The first material comprises a binder material. The first material has a first initial setting time T1. The first flow has a first viscosity V1 ranging between 0.1 Pa·s and 60 Pa·s and a first yield stress Y1. The second flow comprises a second material and water. The second material comprises a carrier material comprising powdery material and at least one additional compound. The additional compound is a compound that, when added to the first material to form a mixture of the first material and the additional compound, being able to reduce the initial setting time of the mixture compared to said first initial setting time T1.

The second material has a second initial setting time T2. The second flow has a second viscosity V2 ranging between 0.1 Pa·s and 60 Pa·s and a second yield stress Y2. The first viscosity V1 and the second viscosity V2 define a ratio V1/V2 ranging between 1/40 and 40. The second initial setting time T2 is larger than the first initial setting time T1. The first flow and the second flow are mixed in the static mixer to obtain a third flow comprising the extrudable concrete. The third flow comprises a mixture of the first material, the second material and water. The mixture of the first material and the second material has a third initial setting time T3. The third flow has a third viscosity V3 and a third yield stress Y3. The third viscosity V3 is larger than the first viscosity V1 and larger than the second viscosity V2. The third yield stress Y3 is larger than the first yield stress Y1 and larger than the second yield stress Y2. The third initial setting time T3 is shorter than the first initial setting time T1. As the second initial setting time T2 is equal or larger than the first initial setting time T1, the third initial setting time T3 is shorter than the second initial setting time T2.

The system comprises preferably a first pump for pumping the first flow to the static mixer and a second pump for pumping the second flow to the static mixer.

The system is in particular suitable for layer-by-layer deposition such as 3D printing of concrete.

### BRIEF DESCRIPTION OF THE DRAWINGS

The present invention will be discussed in more detail below, with reference to the attached drawings, in which:

FIG. 1 shows a system to extrude concrete according to the present invention;

FIG. 2 shows some schematic illustrations of static mixers;

FIG. 3 shows the initial setting time T1 of the first material of the first flow, the initial setting time T2 of the second material of the second flow and the initial setting time T3 of the material of the extrudable concrete.

### DESCRIPTION OF EMBODIMENTS

The present invention will be described with respect to particular embodiments and with reference to certain drawings but the invention is not limited thereto but only by the claims. The drawings are only schematic and are non-limiting. The size of some of the elements in the drawing may be exaggerated and not drawn on scale for illustrative purposes. The dimensions and the relative dimensions do not correspond to actual reductions to practice of the invention.

When referring to the endpoints of a range, the endpoint values of the range are included.

When describing the invention, the terms used are construed in accordance with the following definitions, unless indicated otherwise.

The term ‘and/or’ when listing two or more items, means that any one of the listed items can by employed by itself or that any combination of two or more of the listed items can be employed.

The terms ‘first’, ‘second’ and the like used in the description as well as in the claims, are used to distinguish between similar elements and not necessarily describe a sequence, either temporally, spatially, in ranking or in any other manner. It is to be understood that the terms so used are interchangeable under appropriate circumstances.

The term ‘static mixer’ refers to devices for continuous mixing of fluid materials not using moving parts.

The term ‘plasticizer’ and the term ‘superplasticizer’ refer to a chemical additive in concrete used to (1) reduce the water/cement ratio and/or (2) prevent particle agglomeration of cement particles.

The term ‘retarder’ refers to a chemical additive used to postpone cement hydration and to keep a cementitious material workable.

The term ‘accelerator’ refers to a chemical additive that contrary to retarders, accelerates the setting time of cementitious materials, in particular the initial setting time of cementitious material.

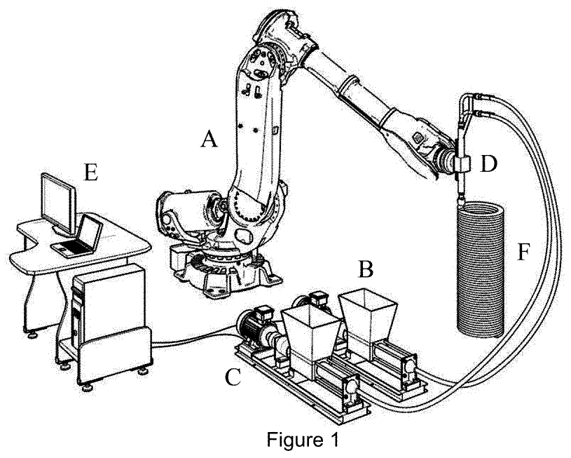

FIG. 1 shows a system 100 to extrude concrete according to the present invention. The system 100 comprises a robot having a robotic arm A. A first flow comprising a binder material and water is pumped by means of a first pump B to a static mixer D. A second flow comprising a carrier material and at least one additional compound is pumped by means of a second pump C to the static mixer D. The material of the first flow and the material of the second flow are mixed by the static mixer D and the mixture is extruded from the nozzle of the deposition head of the 3D printer to form the 3D printed object F. The first pump B, the second pump C and the extruder are controlled by the controller E. The concrete is placed by robot arm A. Movements of the robot arm are controlled by controller E. Once mixed by the static mixer the mixture should be sufficiently fluid to allow conveying and extrusion. On the other hand, the mixture should provide the required mechanical stability of the 3D printed object F.

The first flow comprises for example sand (850 kg/m³), ordinary Portland cement (850 kg/m³), tap water (297.5 kg/m³), and superplasticizer (2.55 kg/m³). The second flow comprises for example sand (763.7 kg/m³), limestone powder (742.8 kg/m³), tap water (267.8 kg/m³), superplasticizer (3.9 kg/m³), viscosity modifying admixture (0.9 kg/m³) and accelerator (120.9 kg/m³).

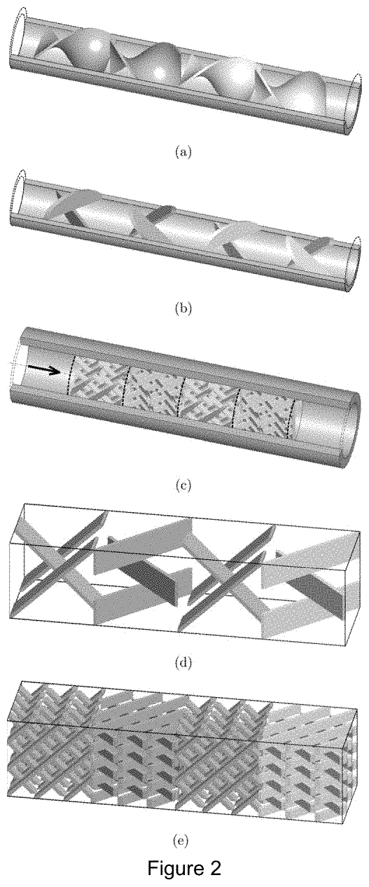

Any type of static mixer known in the art can be considered. Examples comprise plate type static mixers. Alternatively, housed-elements designs mixers comprising a series of baffles can be considered such as static mixers comprising helical mixing elements (right or left hand or alternating right and left hand mixing elements). FIG. 2 shows some schematic illustration of static mixers. FIG. 2(a) shows a Kenics® static mixer with a right twist-left twist and an angle of blade twists of 180°. FIG. 2(b) shows a Ross LPD (Low Pressure Drop) static mixer having semi-elliptical plates with right rotation—left rotation and a crossing angle of 90°. FIG. 2(c) shows a standard Sulzer® SMX static mixer with (n, Nₚ, Nₓ)=(number of crosses over the height, number of parallel bars over the length, number of crossing bars over the width)=(2, 3, 8).

FIG. 2(d) and FIG. 2(e) show two examples of SMX static mixers with (n, Nₚ, Nₓ)=(n, 2n−1, 3n). FIG. 2(d) shows a rectangular version with n=1 and FIG. 2e) shows a compact version with n=3. It is clear that other types of static mixers can be considered as well.

Any type of pump known in the art that is able to pump the first and/or the second flow can be considered. The pumps are preferably able to deliver high viscosity fluids with a steady flow rate. Alternatively, positive displacement pumps can be considered. In positive displacement pumps a fluid is moved by trapping a fixed amount and forcing that trapped volume into the discharge pipe. Examples of such pumps comprise progressive cavity pumps, peristaltic pumps, impulse pumps with several cavities, gear pumps, and screw pump. It is clear that other types of pumps can be considered as well.

### EXPERIMENTAL RESULTS

### Starting Material

The following starting materials are used:
Binder material: ordinary Portland cement (OPC),
Carrier material: Limestone powder (LP) having a particle size ranging between 0.4 to 40 μm and an average particle size around 3 μm,
Superplasticizer (SP): polycarboxylate ether (MasterGlenium 51 from BASF),
Viscosity modifying admixture (VMA): hydroxypropyl methyl cellulose (MOT 60,000 YP4 from Shin-Etsu) (VMA),
Accelerator (ACC): aluminate salts (49-AF from Sika).

The chemical composition of OPC and LP are given in Table 1.

TABLE 1

| Wt(%) | CaO | SiO₂ | Al₂O₃ | Fe₂O₃ | MgO | Na₂O | K₂O | SO₃ | Cl⁻ | LOI |
|---|---|---|---|---|---|---|---|---|---|---|
| OPC | 64.3 | 18.3 | 5.2 | 4.0 | 1.4 | 0.32 | 0.43 | 3.5 | 0.06 | 2.7 |
| LP | 48.85 | 8.15 | 1.28 | 0.88 | 1.41 | 1.25 | 0.28 | 0.05 | — | 37.29 |

With LOI: Loss on ignition

The compositions of the first flow and the second flow as shown in Table 2 were prepared according to mixing protocols shown in Table 3 (First flow) and Table 4 (Second flow).

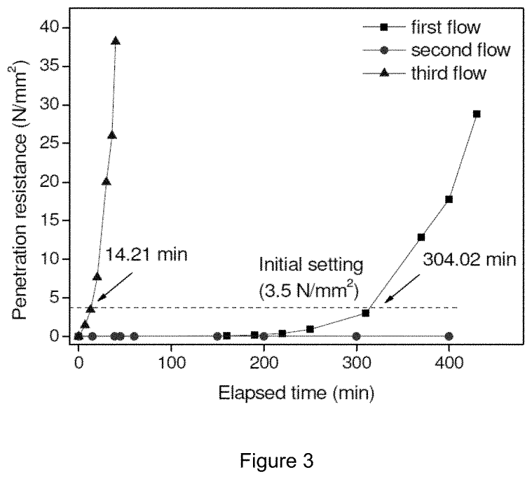

The first initial setting time T1 of the first material of the first flow and the second initial setting time T2 of the second material of the second flow are shown in FIG. 3. The flow diameters of the first flow, the second flow and the third flow, which are measured by a flow table test, are 289 mm, 300 mm and 136 mm, respectively. It is clear that the first flow and the second flow show a high fluidity while the third flow shows a low fluidity.

A tubular shaped 3D object having an outer diameter of 40 cm and a wall thickness of 5 cm was 3D printed. A height of the 3D object of 1.7 m was obtained in 5 minutes during a first test. In another test a height of the tubular shaped 3D object of 3 m was obtained in 9 minutes.

TABLE 2

| Compositions | | | | | | | |
|---|---|---|---|---|---|---|---|
| (in kg/m³) | Sand | OPC | LP | Water | SP | VMA | ACC |
| First flow | 850 | 850 | 0 | 297.5 | 2.55 | 0 | 0 |
| Second flow | 863.7 | 0 | 742.8 | 267.8 | 3.9 | 0.9 | 120.9 |

Note:
the volume ratio between the first flow and the second flow is 2.

TABLE 3

| Step | Action | Duration |
|---|---|---|
| 1 | Add SP into water | — |
| 2 | Add water into binder (OPC) | — |
| 3 | Mix with 140 rpm | 30 s |
| 4 | Add sand and mix with 140 rpm | 30 s |
| 5 | Mix with 285 rpm | 30 s |
| 6 | Scrape | 30 s |
| 7 | Keep rest | 60 s |
| 8 | Mix with 285 rpm | 60 s |

With rpm being revolutions per minute

TABLE 4

| Step | Action | Duration |
|---|---|---|
| 1 | Add SP into water | — |
| 2 | Add water into powders (LP, VMA, and ACC) | — |
| 3 | Mix with 140 rpm | 30 s |
| 4 | Add sand and mix with 140 rpm | 30 s |
| 5 | Mix with 285 rpm | 30 s |
| 6 | Scrape | 30 s |
| 7 | Keep rest | 60 s |
| 8 | Mix with 285 rpm | 60 s |

Further examples of composition of the first and second flow are given in Table 5, Table 6 and Table 7.

TABLE 5

| Compositions | | | | | | | |
|---|---|---|---|---|---|---|---|
| (in kg/m³) | Sand | OPC | LP | Water | SP | VMA | ACC |
| First flow | 712.9 | 1069.4 | 0 | 396.7 | 5.7 | 0 | 0 |
| Second flow | 1425.9 | 0 | 712.9 | 204.8 | 5.7 | 2.9 | 149.7 |

TABLE 6

| | | Calcium | | | | | | |
|---|---|---|---|---|---|---|---|---|
| Compositions | | sulfoaluminate | quartz | | | | | |
| (in kg/m³) | Sand | cement | powder | Water | SP | VMA | Retarder | ACC |
| First flow | 998.1 | 1069.4 | 0 | 300.9 | 5.7 | 0 | 20 | 0 |
| Second flow | 855.5 | 0 | 712.9 | 417.6 | 5.7 | 2.9 | 0 | 149.7 |

TABLE 7

| | | | Bast | | | | Sodium |
|---|---|---|---|---|---|---|---|
| Compositions | | Fly | furnace | Quartz | | | hydroxide |
| (in kg/m³) | Sand | ash | slag | powder | Water | SP | solution |
| First flow | 1140.7 | 500.4 | 559.3 | 0 | 237.1 | 5.7 | 0 |
| Second flow | 570.4 | 0 | 0 | 712.9 | 0 | 0 | 673.7 |

1. A method for layer-by-layer deposition of concrete, said method comprising providing extrudable concrete by
supplying a first flow and a second flow to a static mixer,
said first flow comprising a first material and water, said first material comprising a binder material and having a first initial setting time T1, said first flow having a first viscosity V1 ranging between 0.1 Pa·s and 60 Pa·s and a first yield stress Y1,
said second flow comprising a second material and water, said second material comprising a carrier material comprising powdery material and at least one additional compound, said additional compound being a compound, when added to said first material to form a mixture of said first material and said additional compound, being able to reduce the initial setting time of said mixture compared to said first initial setting time T1,
said second material having a second initial setting time T2, said second flow having a second viscosity V2 ranging between 0.1 Pa·s and 60 Pa·s and a second yield stress Y2, whereby said first viscosity V1 and said second viscosity V2 define a ratio V1/V2 ranging between 1/40 and 40 and whereby said second initial setting time T2 is equal to or larger than said first initial setting time T1;
mixing said first flow and said second flow in said static mixer to obtain a third flow comprising said extrudable concrete, said third flow comprising a mixture of said first material and said second material and optionally comprising water, said mixture of said first material and said second material having a third initial setting time T3, said third flow having a third viscosity V3 and a third yield stress Y3, whereby said third viscosity V3 is larger than said first viscosity V1 and larger than said second viscosity V2, whereby said third yield stress Y3 is larger than said first yield stress Y1 and larger than said second yield stress Y2 and whereby said third initial setting time T3 is shorter than said first initial setting time T1;
dispensing said third flow from said static mixer.

2. The method according to claim 1, wherein said first and said second flow are supplied to said static mixer by pumping.

3. The method according to claim 1, wherein said carrier material comprises powdery material having an average particle size lower than 100 μm.

4. The method according to claim 1, wherein said third initial setting time T3 is shorter than half of said first initial setting time T1.

5. The method according to claim 1, wherein said third viscosity V3 is at least 2 times said first viscosity V1 or at least 2 times said second viscosity V2 and/or wherein said third yield stress Y3 is at least 200 times said first yield stress Y1 or at least 200 times said second yield stress Y2.

6. The method according to claim 1, wherein said ratio V1/V2 ranges between 1/20 and 20.

7. The method according to claim 1, wherein said first flow is supplied to said static mixer with a flow rate F1 and said second flow is supplied to said static mixer with a flow rate F2, with said ratio F1/F2 ranging between 1/10 and 10.

8. The method according to claim 1, wherein said first flow is supplied to the static mixer by pumping said material of said first flow by a first pump and said second flow is supplied to the static mixer by pumping said material of said second flow by a second pump.

9. The method according to claim 1, wherein said binder material comprises a cementitious binder material and/or an alkali activated binder material.

10. The method according to claim 1, wherein said second flow is free (or substantially free) of said binder material.

11. The method according to claim 1, wherein said carrier material is selected from the group consisting of limestone filler and mineral powders such as sand or quartz powder.

12. The method according to claim 1, wherein said additional compound comprises a setting and/or hardening accelerator, said setting and/or hardening accelerator comprising an inorganic salt, preferably an inorganic salt of alkali and earth alkali metals, an organic salt or a compound selected from the group consisting of amines and/or organic acids and their salts.

13. The method according to claim 1, wherein said additional compound comprises an alkali activator comprising a metal hydroxide, preferably an alkali hydroxide selected, a non-silicate weak acid salt, a silicate, an aluminate, an aluminosilicate or a non-silicate strong acid salt.

14. A system for layer-by-layer deposition of concrete, said system comprising a static mixer having at least a first inlet for introducing a first flow in said static mixer, at least a second inlet for introducing a second flow in said static mixer and at least one outlet for providing a third flow, whereby said first flow comprises a first material, said first material comprising binder material and water, said first flow having a first viscosity V1 ranging between 0.1 Pa·s and 60 Pa·s and a first yield stress Y1, said first material having a first initial setting time T1, said second flow comprising a second material and water, said second material comprising a carrier material comprising powdery material and at least one additional compound,
said additional compound being a compound when added to said first flow of material being able to reduce the first initial setting time T1 of said first flow of material,
said second flow having a second viscosity V2 ranging between 0.1 Pa·s and 60 Pa·s and a second yield stress Y2, said second material having an initial setting time T2, whereby said first viscosity V1 and said second viscosity V2 define a ratio V1/V2 ranging between 1/40 and 40 and whereby said second initial setting time T2 is equal to or larger than said first initial setting time T1; said material of said first flow and said material of said second flow being mixed in said static mixer to obtain said third flow comprising said extrudable concrete, said third flow comprising a mixture of said first material, said second material and a water, said mixture of said first material and said second material having a third initial setting time T3. said third flow having a third viscosity V3 and a third yield stress Y3, whereby said third viscosity V3 is larger than said first viscosity V1 and larger than said second viscosity V2, whereby said third yield stress Y3 is larger than said first yield stress Y1 and larger than said second yield stress Y2 and whereby said third initial setting time T3 is shorter than said first initial setting time T1.
